(19) United States
(12) Patent Application Publication
(10) Pub. No.: US 2009/0185874 A1
(43) Pub. Date: Jul. 23, 2009

(54) GLASS CUTTING TOOL

(75) Inventor: Lu-Chia LIAO, Taichung (TW)

Correspondence Address: BROWDY AND NEIMARK, P.L.L.C.;624 NINTH STREET, NW, SUITE 300, WASHINGTON, DC, 20001-5303, US

(73) Assignee: GRAIN ELECTRONICS, INC., TAICHUNG CITY (TW)

(21) Appl. No.: 12/145,940

(22) Filed: Jun. 25, 2008

(30) Foreign Application Priority Data
Jan. 21, 2008 (TW) 97201307

(51) Int. Cl. B26D 1/14; B26D 3/00; B24B 7/24

(52) U.S. Cl. 407/53; 407/115; 451/178; 83/676

(57) ABSTRACT

A glass cutting tool includes a cutter body provided at a bottom portion thereof with a hole-cutting portion. The hole-cutting portion has a circular cross section and a recessed hole recessed inwardly from a bottom end thereof, such that the contact area between the hole-cutting portion and a workpiece of glass panel can be minimized when the hole-cutting portion is rotated to work on the glass panel, thereby avoiding cracking of the glass panel during working and lowering the defect rate and processing cost.

### BACKGROUND OF THE INVENTION

1. Field of the Invention

The present invention relates generally to cutting tools for use in a glass processing work and more particularly, to a glass cutting tool that can effectively lower the defect rate in the glass processing work.

2. Description of the Related Art

In a working process of a glass panel, for example, a process of cutting a circular hole in a glass panel, a glass cutting tool having a hole-cutting portion is generally used. The cutting tool is held and driven by a driving mechanism to rotate so as to enable the hole-cutting portion to drill a circular hole in the glass panel. For cutting a rectangular or polygonal hole in a glass panel, a circular hole is drilled in the glass panel at first, and then a milling tool is inserted into the cut circular hole and operated to mill the cut circular hole into the desired rectangular or polygonal shape, and then a chamfering tool is used and operated to trim the edge of the rectangular or polygonal hole to the desired perfect status.

A conventional glass cutting tool generally comprises a hole-cutting portion. The hole-cutting portion has a circular cross section and is solid. Because the hole-cutting portion is solid, a relatively larger contact area between the hole-cutting portion and the workpiece exits. If an excessive pressure is applied accidentally when attaching the hole-cutting portion to the glass panel to be cut, the fragile glass panel may break. Therefore, a conventional glass processing method has a high defect rate, resulting in a high processing cost.

Further, many different processing tools including hole-cutting tool, milling tool and chamfering tool may be necessary when processing a glass panel. Changing the processing tool during the processing of a glass panel is time-consuming. Further, preparing a set of different processing tools greatly increases the implement cost.

### SUMMARY OF THE INVENTION

The present invention has been accomplished in view of the above-noted circumstances in view. It is the primary objective of the present invention to provide a glass cutting tool, which reduces the contact area between the tool and the workpiece, thereby lowering the defect rate and processing cost.

It is another objective of the present invention to provide a glass cutting tool, which achieves different processing requirements, saving much the processing cost.

To achieve these objectives of the present invention, the glass cutting tool comprises a cutter body provided at a bottom portion thereof with a hole-cutting portion. The hole-cutting portion has a circular cross section and a recessed hole recessed inwardly from a bottom end thereof. By means of the design of the recessed hole, the contact area between the cylindrical hole-cutting portion is minimized, and therefore operating the glass cutting tool to cut a hole in the workpiece of glass panel does not cause the workpiece to break easily.

According to another aspect of the present invention, the cutter body further comprises a grinding portion above the hole-cutting portion, and chamfering portions above the grinding portion at different elevations. Therefore, one single glass cutting tool of the present invention can be used to achieve different processing requirements, saving much labor and time and reducing the processing cost.

Further scope of applicability of the present invention will become apparent from the detailed description given hereinafter. However, it should be understood that the detailed description and specific examples, while indicating preferred embodiments of the invention, are given by way of illustration only, since various changes and modifications within the spirit and scope of the invention will become apparent to those skilled in the art from this detailed description.

### BRIEF DESCRIPTION OF THE DRAWING

The present invention will become more fully understood from the detailed description given herein below and the accompanying drawings which are given by way of illustration only, and thus are not limitative of the present invention, and wherein:

FIG. 1 is a schematic side view of a glass cutting tool in accordance with a preferred embodiment of the present invention;

FIG. 2 is a bottom view of the glass cutting tool in accordance with the preferred embodiment of the present invention;

FIG. 3 is a schematic drawing showing the hole-cutting portion of the cutter body cut through a glass panel; and

FIG. 4 is a schematic drawing, showing that a chamfering portion of the glass cutting tool works on the circumference wall surrounding the through hole in the glass panel.

### DETAILED DESCRIPTION OF THE INVENTION

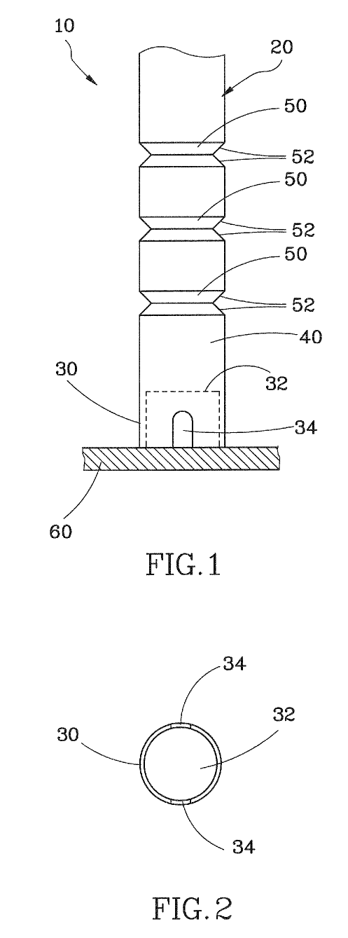

Referring to FIGS. 1 and 2, a glass cutting tool 10 in accordance with a preferred embodiment of the present invention is shown comprising a cutter body 20.

The cutter body 20 is a diamond sintered member rotatable by a driving mechanism (not shown). The cutter body 20 comprises a hole-cutting portion 30, a grinding portion 40, and three chamfering portions 50. The hole-cutting portion 30 is provided at the bottom portion of the cutter body 20, having a circular cross section. The hole-cutting portion 30 has a recessed hole 32 recessed inwardly from the bottom end thereof toward the top side thereof with a certain depth, defining a circular open space. The hole-cutting portion 30 further has two chip-conveying notches 34 disposed in communication with the recessed hole 32 at two opposite sides for discharging cutting chips of the workpiece out of the recessed hole 32. The grinding portion 40 is formed on the cutter body at a location above the top side of the hole-cutting portion 30 and has a smooth circumference periphery. The three chamfering portions 50 are spacedly formed on the cutter body 20 above the top side of the grinding portion 40, and equally spaced one above another. Each chamfering portion 50 has two slope surfaces 52.

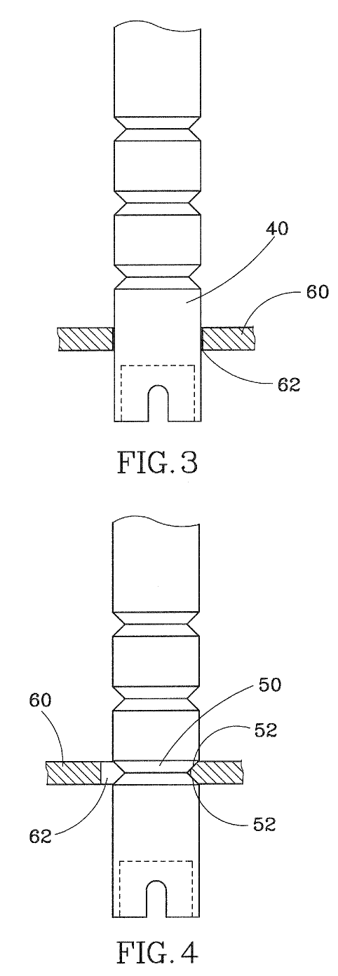

When using the glass cutting tool 10 to cut a glass panel 60, the user may start the driving mechanism to rotate the cutter body 20, and then lower the glass cutting tool 10 to move toward the glass panel 60 to force the hole-cutting portion 30 of the cutter body 20 into contact with the glass panel 60, as shown in FIG. 1. As shown in FIG. 2, because the hole-cutting portion 30 has the design of recessed hole 32, the contact area between the hole-cutting portion 30 and the glass panel 60 is relatively smaller than the contact area between the hole-cutting portion of a similar conventional glass cutting tool and the workpiece of glass panel. Therefore, the hole-cutting portion 30 can cut a circular hole 62 on the glass panel 60 at a speed quicker than the application of a conventional glass cutting tool (less workpiece cutting consumption) without causing the glass panel 60 to crack (the workpiece receives less pressure). Further, cutting chips of the glass panel 60 can be expelled to the outside through the chip-conveying notches 34 of the hole-cutting portion 30 rapidly during working. Thereafter, the glass cutting tool 10 can be lowered to grind the circumference wall that surrounds the hole 62 with the grinding portion 40, as shown in FIG. 3, thereby smoothening the inner surface of the hole 62. Thereafter, the glass cutting tool 10 can be further lowered to grind the circumference wall of the hole 62 with the two slope surfaces 52 of one chamfering portion 50, processing the circumference wall of the hole 62 into a chamfered edge, as shown in FIG. 4.

By means of the design of recessed hole, the invention effectively reduces the contact area between the hole-cutting portion and the glass panel, avoiding cracking of the glass panel during working and lowering the defect rate and processing cost.

Further, the glass cutting tool of the present invention has a grinding portion and multiple chamfering portions. Therefore, one single glass cutting tool can be used to achieve different processing works, saving much labor and time. In consequence, the processing cost is greatly reduced.

In conclusion, the invention provides a glass cutting tool that has the following features and advantages:

1. High process yield rate: The design of the recessed hole in the bottom side of the hole-cutting portion greatly reduces the contact area between the hole-cutting portion and the glass panel, avoiding cracking of the glass panel during cutting, and therefore the process yield rate can be as high as over 98%.

2. Low processing cost: This includes two ways: one is to shorten the processing time, and the other is to reduce the implement cost. Shortening of the processing time is achieved partially by the design of the recessed hole in the bottom side of the hole-cutting portion to greatly reduce the contact area between the hole-cutting portion and the glass panel and to further reduce the workpiece cutting consumption and accelerate the processing speed, and partially by the use of one single glass cutting tool of which the cutter body comprises a hole-cutting portion, a grinding portion and three chamfering portions. By means of the use of one single glass cutting tool to achieve the hole processing work, the invention saves the time in changing glass cutting tool during the hole cutting work. Reducing implement cost is achieved by means of the use of one single glass cutting tool to achieve the hole processing work. Because the cutter body of the glass cutting tool according to the present invention comprises a hole-cutting portion, a grinding portion and three chamfering portions, one single glass cutting tool is sufficient to complete the hole processing work.

The invention being thus described, it will be obvious that the same may be varied in many ways. Such variations are not to be regarded as a departure from the spirit and scope of the invention, and all such modifications as would be obvious to one skilled in the art are intended to be included within the scope of the following claims.

What is claimed is:

1. A glass cutting tool comprising a cutter body having a hole-cutting portion at a bottom portion thereof;
wherein said hole-cutting portion has a circular cross section and a recessed hole recessed inwardly from a bottom end thereof.

2. The glass cutting tool as claimed in claim 1, wherein said cutter body further comprises a grinding portion located above said hole-cutting portion and having a smooth circumference periphery.

3. The glass cutting tool as claimed in claim 2, wherein said cutter body further comprises at least one chamfering portion located above said grinding portion.

4. The glass cutting tool as claimed in claim 3, wherein said at least one chamfering portion has two slope surfaces.

5. The glass cutting tool as claimed in claim 3, wherein said cutter body comprises a plurality of said chamfering portions spaced from one another.

6. The glass cutting tool as claimed in claim 1, wherein said hole-cutting portion has at least one chip-conveying in communication with said recessed hole.

7. The glass cutting tool as claimed in claim 6, wherein said hole-cutting portion comprises two said chip-conveying notches, which are disposed at two opposite sides relative to said recessed hole.
